(19) United States
(12) Patent Application Publication
(10) Pub. No.: US 2014/0260978 A1
(43) Pub. Date: Sep. 18, 2014

(54) REVERSE COOLING DESICCANT REGENERATION

(71) Applicant: PARKER-HANNIFIN CORPORATION, Cleveland, OH (US)

(72) Inventor: Daniel Blaszkowiak, Lancaster, NY (US)

(73) Assignee: PARKER-HANNIFIN CORPORATION, Cleveland, OH (US)

(21) Appl. No.: 13/833,720

(22) Filed: Mar. 15, 2013

(51) Int. Cl. B01D 53/26

(52) U.S. Cl. CPC B01D 53/261
USPC 95/122; 96/144; 96/126; 96/115; 96/109

(57) ABSTRACT

Provided is an air drying system that includes a desiccant container including desiccant material for removing moisture from a pressurized air stream directed through the container in a first direction, a heater coupled to the container for selectively providing heated air to the container in a second direction opposite the first direction, and an air source coupled to the container for selectively providing cooled air to the container in the first direction. By introducing the cooled air in the opposite direction as the heated air, the duration of the cooling can be extended to allow for further removal of adsorbed moisture from the desiccant, thereby lowering the dew point. The extended duration of cooling also allows for additional removal of heat from the desiccant container to minimize heat spikes when the desiccant container is switched to the adsorbing cycle.

### RELATED APPLICATIONS

This application claims the benefit of U.S. Provisional Application No. 61/624,501 filed Apr. 16, 2012, which is hereby incorporated herein by reference.

### FIELD OF INVENTION

The present invention relates generally to air drying systems, and more particularly to air drying systems using a desiccant regeneration process.

### BACKGROUND

Air drying systems may be used to remove moisture vapor from a stream of compressed air. The air drying systems can include an air drying assembly having a moisture adsorbing material to adsorb moisture from the air. If the air drying system includes two air drying assemblies, the air drying system alternately cycles between removing moisture from air passing through a first assembly while regenerating the moisture adsorbing material in the second assembly. To regenerate the second assembly, heat and/or purge flow are passed over the adsorbing material to dry the adsorbing material.

### SUMMARY OF INVENTION

The present invention provides an air drying system that includes a desiccant container including desiccant material for removing moisture from a pressurized air stream directed through the container in a first direction, a heater coupled to the container for selectively providing heated air to the container in a second direction opposite the first direction, and an air source coupled to the container for selectively providing cooled air to the container in the first direction. By introducing the cooled air in the opposite direction as the heated air, the duration of the cooling can be extended to allow for further removal of adsorbed moisture from the desiccant, thereby lowering the dew point. The extended duration of cooling also allows for additional removal of heat from the desiccant container to minimize heat spikes when the desiccant container is switched to the adsorbing cycle.

According to one aspect of the invention, an air drying system is provided that includes a first desiccant container including desiccant material for removing moisture from a pressurized air stream directed through the container in a first direction, a heater coupled to the container for selectively providing heated air to the container in a second direction opposite the first direction for removing moisture from the desiccant material by drying the material, and an air source coupled to the container for selectively providing cooled air to the container in the first direction for removing moisture and heat from the desiccant material.

The system further comprises a second desiccant container including desiccant material for removing moisture from a pressurized air stream directed through the second container in the first direction, wherein the heater and air source are coupled to the second container.

The system further comprises a pressurized air source coupled to the first and second containers for selectively providing the pressurized air stream to the containers in the first direction.

The system further comprises one or more controllers for directing the pressurized air to one of the first and second containers during an adsorption cycle and for directing the heated and cooled air to the other of the first and second containers during a regenerating cycle.

The one or more controllers is configured to direct the cooled air to the other of the first and second containers after the heated air has been directed to the other of the first and second containers.

The one or more controllers are configured to selectively switch flow through the system such that one of the containers is under the regenerating cycle while the other container is under the adsorption cycle.

The system further comprises first and second heating exhaust valves for exhausting the heated air from the first and second containers respectively.

The system further comprises first and second cooling exhaust valves separate from the heating exhaust valves for exhausting the cooled air from the first and second containers respectively.

The system further comprises a heater isolation valve movable between an open position to allow air to flow to the heater and a closed position when the cooled air is provided to the container.

The system further comprises first and second cooling inlet valves through which the cooled air flows to the first and second containers respectively.

The system further comprises first and second pressurized air inlet valves separate from the first and second cooling inlet valves through which the pressurized air stream flows to the first and second containers respectively.

According to another aspect of the invention, an air drying system is provided comprising first and second desiccant containers including desiccant material for removing moisture from a pressurized air stream directed through the containers in a first direction, a heater coupled to the first and second containers for selectively providing heated air to the containers in a second direction opposite the first direction for removing moisture from the desiccant material by drying the material, an air source coupled to the first and second containers for selectively providing cooled air to the container in the first direction for removing moisture and heat from the desiccant material and for providing air to the heater, a pressurized air source coupled to the first and second containers for selectively providing the pressurized air stream to the containers in the first direction, and one or more controllers configured to direct the pressurized air to one of the first and second containers during an adsorption cycle and to direct the heated and cooled air to the other of the first and second containers during a regenerating cycle, wherein the one or more controllers is configured to direct the cooled air to the other of the first and second containers after the heated air has been directed to the other of the first and second containers, and wherein the one or more controllers is configured to selectively switch flow through the system such that one of the containers is under the regenerating cycle while the other container is under the adsorption cycle.

According to yet another aspect of the invention, a method for drying air and regenerating saturated desiccant material in a first container in an air drying system is provided. The method includes directing heated air through the container in a second direction to remove moisture from the desiccant material by drying the material, and directing air through the container in a first direction opposite the second direction to remove moisture and heat from the desiccant material.

The air drying system additionally includes a second container including desiccant material, and the method further includes directing air from a pressurized air source through one of the first or second containers in the first direction during an adsorption cycle to remove moisture from the air via the desiccant material, directing heated air through the other one of the first or second containers in the second direction during a heating portion of a regenerating cycle to remove moisture from the desiccant material, and directing cooled air through the other one of the first or second containers in the first direction during a cooling portion of the regenerating cycle after the heating portion to remove moisture and heat from the desiccant material.

Once the desiccant material in the container under the adsorption cycle is saturated, the method further includes selectively switching flow of the pressurized air to the other of the containers.

Flow is selectively switched such that one of the containers is under the regenerating cycle while the other container is under the adsorption cycle.

The method further comprises directing the air in the container under the adsorption cycle to an output device.

The foregoing and other features of the invention are hereinafter described in greater detail with reference to the accompanying drawings.

### BRIEF DESCRIPTION OF THE DRAWINGS

FIG. 1 is a schematic view of an exemplary air drying system according to the invention.

### DETAILED DESCRIPTION

Turning now to FIG. 1, an exemplary air drying system is illustrated generally at reference numeral 10. The air drying system includes one or more desiccant containers, such as first and second desiccant containers 12 and 14. The containers 12 and 14 each include desiccant material, shown in container 12 at reference numeral 16, for removing moisture from an air stream directed through the containers in a first direction, shown by reference numeral 18. The system also includes a heater 20 coupled to the first and second containers 12 and 14 and an air source 22 coupled to the first and second containers for directing cool air, such as ambient air to the containers and air to the heater 20.

The heater 20, which may be any suitable heater, can selectively provide heated air to the containers 12 and 14 in a second direction, shown by reference numeral 24, opposite the first direction 18 for removing moisture from the desiccant material 16 by drying. The air source 22, which may be any suitable air source such as a blower or vacuum pump, can draw in ambient air and selectively provide cooled air to the containers in the first direction 18 for removing moisture and heat from the desiccant material 16. The air source 22 also selectively provides the air to the heater 20 to be introduced into the containers in the second direction.

The system may also include a pressurized air source 26, such as a compressor, coupled to the first and second containers 12 and 14 for selectively providing pressurized air to the containers in the first direction 18. The pressurized air provided to the first and second containers 12 and 14 is moisture laden ambient air drawn into the pressurized air source. The moisture in the air is adsorbed by the desiccant material 16 in the containers, and then the dried air is delivered from the containers to an output 28, such as process piping and/or a reservoir that may be part of the system or that may be separate from the system.

The system 10 also includes a plurality of valves that are controllable by one or more controllers 30 to vary the flow in the system such that pressurized air is directed to one of the first and second containers 12 and 14 during an adsorption cycle and the heated and cooled air are directed to the other of the first and second containers 12 and 14 during a regenerating cycle. The plurality of valves controllable by the one or more controllers 30 include first and second heating exhaust valves 40 and 42, first and second cooling exhaust valves 44 and 46, a heater isolation valve 48, first and second cooling inlet valves 50 and 52, and first and second pressurized air inlet valves 54 and 56.

The first and second heating exhaust valves 40 and 42 are controllable to allow the heated air to be exhausted from the first and second containers 12 and 14, respectively. The first and second cooling exhaust valves 44 and 46, which are separate valves from the heating exhaust valves 40 and 42, are controllable to allow the cooled air to be exhausted from the first and second containers, respectively. The heater isolation valve 48 is movable between an open position to allow the heated air to flow to one of the containers 12 and 14 and a closed position when the cooled air is provided to one of the containers. The first and second cooling inlet valves 50 and 52 are controllable to allow the cooled air from the air source 22 to flow to the first and second containers, respectively. The first and second pressurized air inlet valves 54 and 56, which are separate from the first and second cooling inlet valves 50 and 52, are controllable to allow the pressurized air flow to flow to the first and second containers, respectively. It will be appreciated that the above-described valves may be any suitable valves for selectively controlling the flow of air in the system.

The system also includes a plurality of check valves, which may be any suitable check valve that controls the flow into and out of the containers 12 and 14. The system includes first and second check valves 60 and 62 movable from an open position to allow the heated air to flow to the first and second containers 12 and 14, to a closed position to prevent the dried air and cooled air exiting the first and second containers from flowing towards the heater 20. The system also includes third and fourth check valves 64 and 66 movable from an open position to allow the air streams to flow from the first and second containers to the output 28 to a closed position to prevent dried air from the output from flowing back to the containers 12 and 14.

Referring now to the one or more controllers 30 in detail, the one or more controllers 30 may be any suitable controller, such as a microprocessor based controller or a standalone controller. The controllers 30 are coupled to the valves as discussed above and to the air source 22, pressurized air source 26, and the heater 20 to control the components. The one or more controllers 30 is also coupled to one or more sensors 70 disposed in and/or around the containers 12 and 14 to sense one or more of temperature inside the containers, moisture inside the containers, time of adsorption, dew point inside the containers, etc. Based on the sensors measurements, the one or more controllers 30 controls the plurality of valves to selectively switch the flow through the system 10 such that one of the containers 12 or 14 is under the regenerating cycle while the other container 12 or 14 is under the adsorption cycle.

Referring again to the schematic illustration FIG. 1, an exemplary method for drying air and regenerating saturated desiccant material in the first and second container 12 and 14 will be described. As noted above, during operation of the system 10, one of the first and second containers 12 or 14 will be under the regenerating cycle while the other of the first and second containers is under the adsorption cycle. When the second desiccant container 14 is under the adsorption cycle, otherwise known as an on-line container, as shown in FIG. 1, air from the pressurized air source 26, such as pressurized moisture laden air, is directed through the second pressurized air inlet valve 56 to the second desiccant container 14 in the first direction 18. As this occurs, the first pressurized air inlet valve 54 and the second heat exhaust valve 42 are closed to prevent the pressurized air from flowing to the first container 12 or from being exhausted, respectively.

The moisture in the pressurized air flowing through the second desiccant container 14 is then adsorbed by the desiccant material 16. The dry air then flows out of the second desiccant container 14, through the fourth check valve 66 that opens from the air pressure, to the output 28. As this occurs, the cooling exhaust valve 46 is closed to prevent the dried air from being exhausted and the second check valve 62 is in the closed position to prevent the dried air from flowing towards the heater 20. The pressurized air continues to flow through the second desiccant container 14 until a predetermined condition occurs, such as a predetermined time has elapsed or the desiccant material 16 has reached a predetermined level of saturation.

While the second desiccant container 14 is under the adsorption cycle, the first desiccant container 12 is under the regenerating cycle, otherwise known as an off-line or standby container. When the first desiccant container 12 is under the regenerating cycle, air from the air source 22 is directed through the heater isolation valve 48 to the heater 20. As this occurs, the first and second cooling inlet valves 50 and 52 are closed to prevent cooling air from flowing into either one of the first and second desiccant container 12 and 14. The air is then heated to a predetermined temperature in the heater 20, and then directed through the first check valve 60, which is moved to the open position by the air pressure, to the first container 12 in the second direction 24. As this occurs, the cooling exhaust valve 44 is closed to prevent the heated air from being exhausted and the third check valve 64 is in the closed position to prevent the heated air from flowing towards the output 28.

The heated air then flows through the first desiccant container 12 over the desiccant material 16 for a predetermined amount of time, until the one or more sensors 70 senses the desiccant material is at predetermined dryness level, etc., to remove at least a portion of the moisture in the saturated desiccant material. As the heated air flows through the first desiccant container 12, the desiccant material 16 at a top portion of the container where the heated air enters is dried the most and the desiccant material at a bottom portion of the container where the heated air exits is dried the least. The heated air then flows out of the first desiccant container 12 and is exhausted from the system 10 via the heat exhaust valve 40. As this occurs, the cooling inlet valve 50 and the pressurized air inlet valve 54 are closed to prevent heated air from mixing with the air from the air source 22 and pressurized air source 26, respectively.

After the desiccant material 16 in the first desiccant container 12 has been heated, for example for the predetermined amount of time, the heater 20 is shut off and the heater isolation valve 48 is closed by the one or more controllers 30. Air from the air source 22 is then directed through the first cooling inlet valve 50 to the first desiccant container 12 in the first direction. As this occurs, the second cooling inlet valve 52 is closed to prevent cooled air from flowing to the second desiccant container 14 and the heater isolation valve 48 is closed to prevent air from flowing to the heater 20. The cool air flows through the first desiccant container 12 past the desiccant material 16, for example for a predetermined amount of time to remove moisture and heat from the desiccant material 16. The air then flows out of the first desiccant container 12 and is exhausted from the system 10 via the first cooling exhaust valve 44. As this occurs, both the first and third check valves 60 and 64 remain in the closed position to prevent the exhausted air from flowing towards the heater 20 and the output 28, respectively.

By introducing the cooled air in the opposite direction as the heated air, the duration of the cooling can be extended to allow for further removal of adsorbed moisture from the desiccant 16, thereby lowering the dew point. The extended duration of cooling also allows for additional removal of heat from the first desiccant container 12 to minimize heat spikes when the first desiccant container is switched to the adsorbing cycle. The system 10 does not incorporate a purge valve to reintroduce dried air from the output 28 to dry the desiccant 16, thereby reducing energy costs associated with drying already processed dried air.

Moreover, when the first desiccant container 12 is switched to the adsorbing cycle and pressurized air is blown towards the top of the first desiccant container 12, residual moisture at the bottom portion of the first desiccant container from heating and/or from the cool air is blown towards the top of the container and adsorbed by the dried desiccant 16. In this way, dew point spikes of air directed to the outlet 28 are reduced due to the lack of saturated desiccant material at the top of the container.

When the predetermined condition occurs during the adsorption cycle of the second desiccant container 14, such as a predetermined time has elapsed or the desiccant material 16 has reached a predetermined level of saturation sensed by the one or more sensors 70, the one or more controllers 30 switches the valves such that the first desiccant container 12 is under the adsorption cycle and the second desiccant container 14 is under the regenerating cycle. When the first desiccant container 12 is under the adsorption cycle, air from the pressurized air source 26 is directed through the first pressurized air inlet valve 54 to the first desiccant container 12 in the first direction 18. As this occurs, the second pressurized air inlet valve 56 and the first heat exhaust valve 40 are closed.

The moisture in the pressurized air flowing through the first desiccant container 12 is then adsorbed by the desiccant material 16. The dry air then flows out of the first desiccant container 12, through the third check valve 64 that opens from the air pressure, to the output 28. As this occurs, the first cooling exhaust valve 44 is closed and the first check valve 60 is in the closed position to prevent the dried air from flowing towards the heater 20.

While the first desiccant container 12 is under the adsorption cycle, the second desiccant container 14 is under the regenerating cycle. When the second desiccant container 14 is under the regenerating cycle, air from the air source 22 is directed through the heater isolation valve 48 to the heater 20. As this occurs, the first and second cooling inlet valves 50 and 52 are closed. The air is then heated in the heater 20 to a predetermined temperature, and then directed through the second check valve 62 to the second container 14 in the second direction 24. As this occurs, the cooling exhaust valve 46 is closed and the fourth check valve 66 is in the closed position to prevent the heated air from flowing towards the output 28.

The heated air flows through the second desiccant container 14 over the desiccant material 16 for a predetermined amount of time, until the one or more sensors 70 senses the desiccant material is at predetermined dryness level, etc., to remove at least a portion of the moisture in the saturated desiccant material. The heated air then flows out of the second desiccant container 14 and is exhausted from the system 10 via the heat exhaust valve 42. As this occurs, the second cooling inlet valve 52 and the second pressurized air inlet valve 56 are closed.

After the desiccant material has been heated, for example for the predetermined amount of time, the heater 20 is shut off and the heater isolation valve 48 is closed by the one or more controllers 30. Air from the air source 22 is directed through the second cooling inlet valve 52 to the second desiccant container 14 in the first direction. As this occurs, the first cooling inlet valve 50 is closed along with the heater isolation valve 48. The cool air flows through the second desiccant container 14 past the desiccant material 16 for a predetermined amount of time to remove moisture and heat from the desiccant material 16. The air then flows out of the second desiccant container 14 and is exhausted from the system 10 via the second cooling exhaust valve 46. As this occurs, both the second and fourth check valves 62 and 66 remain in the closed position.

When the predetermined condition occurs during the adsorption cycle of the first desiccant container 12, the one or more controllers 30 switches the valves such that the second desiccant container 14 is under the adsorption cycle and the first desiccant container 12 is under the regenerating cycle. The first and second containers 12 and 14 thereby alternate between being under the adsorption cycle and being under the regenerating cycle. Although two containers have been described, it will be appreciated that any suitable number of containers may be used in the system 10.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An air drying system including:
a first desiccant container including desiccant material for removing moisture from a pressurized air stream directed through the container in a first direction;
a heater coupled to the container for selectively providing heated air to the container in a second direction opposite the first direction for removing moisture from the desiccant material by drying the material; and
an air source coupled to the container for selectively providing cooled air to the container in the first direction for removing moisture and heat from the desiccant material.

2. The air drying system according to claim 1, further comprising a second desiccant container including desiccant material for removing moisture from a pressurized air stream directed through the second container in the first direction, wherein the heater and air source are coupled to the second container.

3. The air drying system according to claim 1, further comprising a pressurized air source coupled to the first and second containers for selectively providing the pressurized air stream to the containers in the first direction.

4. The air drying system according to claim 3, further comprising one or more controllers for directing the pressurized air to one of the first and second containers during an adsorption cycle and for directing the heated and cooled air to the other of the first and second containers during a regenerating cycle.

5. The air drying system according to claim 4, wherein the one or more controllers is configured to direct the cooled air to the other of the first and second containers after the heated air has been directed to the other of the first and second containers.

6. The air drying system according to claim 4, wherein the one or more controllers is configured to selectively switch flow through the system such that one of the containers is under the regenerating cycle while the other container is under the adsorption cycle.

7. The air drying system according to claim 2, further comprising first and second heating exhaust valves for exhausting the heated air from the first and second containers respectively.

8. The air drying system according to claim 7, further comprising first and second cooling exhaust valves separate from the heating exhaust valves for exhausting the cooled air from the first and second containers respectively.

9. The air drying system according to claim 2, further comprising a heater isolation valve movable between an open position to allow air to flow to the heater and a closed position when the cooled air is provided to the container.

10. The air drying system according to claim 3, further comprising first and second cooling inlet valves through which the cooled air flows to the first and second containers respectively.

11. The air drying system according to claim 10, further comprising first and second pressurized air inlet valves separate from the first and second cooling inlet valves through which the pressurized air stream flows to the first and second containers respectively.

12. The air drying system according to claim 2, further comprising first and second check valves movable to an open position to allow the heated air to flow to the first and second containers respectively.

13. The air drying system according to claim 12, further comprising third and fourth check valves movable to an open position to allow the respective air stream to flow from the first and second containers respectively to an output.

14. An air drying system comprising:
first and second desiccant containers including desiccant material for removing moisture from a pressurized air stream directed through the containers in a first direction;
a heater coupled to the first and second containers for selectively providing heated air to the containers in a second direction opposite the first direction for removing moisture from the desiccant material by drying the material;
an air source coupled to the first and second containers for selectively providing cooled air to the container in the first direction for removing moisture and heat from the desiccant material and for providing air to the heater;
a pressurized air source coupled to the first and second containers for selectively providing the pressurized air stream to the containers in the first direction; and
one or more controllers configured to direct the pressurized air to one of the first and second containers during an adsorption cycle and to direct the heated and cooled air to the other of the first and second containers during a regenerating cycle,
wherein the one or more controllers is configured to direct the cooled air to the other of the first and second containers after the heated air has been directed to the other of the first and second containers, and
wherein the one or more controllers is configured to selectively switch flow through the system such that one of the containers is under the regenerating cycle while the other container is under the adsorption cycle.

15. A method for drying air and regenerating saturated desiccant material in a first container in an air drying system, the method comprising:
directing heated air through the container in a second direction to remove moisture from the desiccant material by drying the material; and
directing air through the container in a first direction opposite the second direction to remove moisture and heat from the desiccant material.

16. The method according to claim 15, wherein the air drying system includes a second container including desiccant material, and wherein the method further comprises:
directing air from a pressurized air source through one of the first or second containers in the first direction during an adsorption cycle to remove moisture from the air via the desiccant material;
directing heated air through the other one of the first or second containers in the second direction during a heating portion of a regenerating cycle to remove moisture from the desiccant material; and
directing air through the other one of the first or second containers in the first direction during a cooling portion of the regenerating cycle after the heating portion to remove moisture and heat from the desiccant material.

17. The method according to claim 16, wherein once the desiccant material in the container under the adsorption cycle is saturated, the method further comprises selectively switching flow of the pressurized air to the other of the containers.

18. The method according to claim 17, wherein flow is selectively switched such that one of the containers is under the regenerating cycle while the other container is under the adsorption cycle.

19. The method according to claim 16, further comprising directing the air in the container under the adsorption cycle to an output device.

20. The method according to claim 15, wherein the heated air is exhausted from the system through a heating exhaust valve and the cooled air is exhausted from the system through a cooling exhaust valve separate from the heating exhaust valve.
